(19) United States
(12) Patent Application Publication
(10) Pub. No.: US 2002/0104190 A1
(43) Pub. Date: Aug. 8, 2002

(54) Child tether cover

(76) Inventors: Donal Moore, Birmingham, MI (US); Brian Bateman, Rochester Hills, MI (US); Paul A. Maloney, Ann Arbor, MI (US)

Correspondence Address: Andrew R. Basile, Young & Basile, P.C., Suite 624, 3001 West Big Beaver Road, Troy, MI, 48084, US

(21) Appl. No.: 09/767,535

(22) Filed: Jan. 23, 2001

(51) Int. Cl. F16L 5/00

(52) U.S. Cl. 16/231

(57) ABSTRACT

A cover for an anchor system, for example a motor vehicle child safety seat anchor system, having an attachment point adjacent a base layer opening and a tether selectively detachably connected to the attachment point. The cover comprises a circumferential flange defining an opening therein, and operatively connected to the base layer opening. A cap is receivable within the circumferential flange opening, is rotatably attached to the circumferential flange, and selectively movable about a pivot point from a closed position to an open position. A notch is defined in at least one of the flange and the cap. The notch allows the tether to pass therethrough when the cap is in the closed position.

### BACKGROUND OF THE INVENTION

The invention relates generally to a child seat attachment system for a motor vehicle and, more particularly, to a cover for an anchor in such a system.

Safety considerations, and in many areas goverunental legislation, require that small children traveling in a vehicle be restrained by equipment specifically designed for this purpose. The restraint systems normally provided in vehicles for improving the safety of adults traveling in the vehicle are generally not suitable for occupants below a certain weight or height. The apparatus most commonly used for restraining children who do not fit the height or weight requirements of the provided restraint system is a child safety seat (commonly referred to as a “car seat”). The child safety seat is generally secured to the vehicle by utilizing the seat belts of the adult restraint system.

Recently, manufacturers of child safety seats have released new designs therefor, resulting from a new standardized child safety seat system. Consequently, most new passenger vehicles are equipped to accommodate the new child safety seat designs. The standardized system is known as LATCH (an acronym standing for “Lower Anchors and Tethers for Children”). Under this new system, vehicles are to be equipped with new, special child seat anchorage points. Child seats will attach to the vehicle seat via these anchorage points, as opposed to the current method of being held by the vehicle's seat belts. The system has three anchorage points: one tether, or upper anchorage and two lower anchorages. The lower anchorages are rigid, round rods located where the vehicle seat cushion meets the seat back. The tether anchorage is a ring-like object, rod, attachment bolt or the like permanently attached to the vehicle, and generally recessed below an internal surface (for example, the package tray) in the vehicle. There is an opening in the internal vehicle surface to provide access to the anchorage point.

There are several drawbacks associated with the tether anchorages. One such drawback is that consumers have found the tethers to be quite aesthetically displeasing. As such, automotive manufacturers have attempted to provide covers in order to hide the tethers. Such covers have generally been configured such that they must be removed and/or remain open while the tether is in use. Consequently, the aesthetically displeasing tether is in full view while in use. A further drawback of having the tether and the opening therearound uncovered while the tether is in use is that objects may inadvertently or purposely be dropped into opening. This is disadvantageous in that the foreign object(s) may interfere with the proper working of the anchorage system, and/or the objects may be lost. A drawback of the cover which must be removed while the tether is in use is that often the covers are lost, thus leaving the tether open to view even while not in use.

Thus, it is an object of the present invention to provide a cover for such an anchorage system which advantageously may cover the anchorage point even while the system is in use. It is a further object of the present invention to provide such a cover which is simple to operate.

### SUMMARY OF THE INVENTION

The present invention addresses and solves the above-mentioned problems and meets the enumerated objects and advantages, as well as others not enumerated, by providing a cover for an anchor system (such as, for example, a motor vehicle child safety seat anchor system) having an attachment point adjacent a base layer opening and a tether selectively detachably connected to the attachment point. The cover of the present invention comprises a circumferential flange defining an opening therein, and adapted to be operatively connected to the base layer opening. A cap is receivable within the circumferential flange opening, the cap being rotatably attached to the circumferential flange and selectively movable about a pivot point from a closed position to an open position. A notch is defined in at least one of the flange and the cap. The notch is adapted to allow the tether to pass therethrough when the cap is in the closed position.

### BRIEF DESCRIPTION OF THE DRAWINGS

Other objects, features and advantages of the present invention will become apparent by reference to the following detailed description and drawings, in which:

FIG. 1 is an exploded perspective view of the anchor system cover of the present invention, showing an attachment/anchorage point/tether adjacent a vehicle base layer;

FIG. 2 is a cutaway perspective view of the cover of the present invention shown installed in the base layer of the vehicle, and showing a tether attached to the attachment point, with the cap in a position intermediate the open position and the closed position, and also showing the cap in the open position in phantom;

FIG. 3 is a cutaway perspective view similar to the view of FIG. 2, but showing the cap in a closed position;

FIG. 4 is a side view of a child seat positioned in a vehicle, showing the tether attached to a lower attachment point, and showing the cover of the present invention installed over the lower attachment point;

FIG. 5 is a cutaway side view of an alternate configuration of an upper attachment point, shown mounted to the package tray, and showing the base layer and schematically showing the cover of the present invention in phantom;

FIG. 6 is a view similar to the view of FIG. 2, except showing an alternate embodiment of the attachment hook;

FIG. 7 is a cutaway perspective view similar to the view of FIG. 6 (without showing the base layer), but showing the cap in a closed position over the alternate embodiment of the attachment hook; and

FIG. 8 is a side view of the attachment hook of FIG. 6, with the tether cut away and the bar in cross section.

### DETAILED DESCRIPTION OF THE PREFERRED EMBODIMENTS

Referring now to FIG. 1, the cover of the present invention is designated generally as 10. Cover 10 may be suitable for an anchor system such as the LATCH system described hereinabove. Exemplary variations of the LATCH system are shown in FIGS. 4 and 5.

Although cover 10 is advantageously for use with a child tether system such as the LATCH system, it is to be understood that cover 10 may find many other suitable uses.

Cover 10 is shown in conjunction with an anchor system having an attachment point 31 adjacent a base layer 34 opening 17 and a tether 40 selectively detachably connected to the attachment point 31. Cover 10 comprises a circumferential flange 12 defining an opening 15 therein, and adapted to be operatively connected to the base layer opening 17. It is to be understood that flange 12 may be, but is not necessarily shaped complementarily to the shape of the base layer opening 17. In some circumstances, it may be desirable to have the base layer opening 17 smaller or larger than the circumferential flange opening 15. Further, base layer opening 17 may be trimmed to accommodate the flange 12 if desired and/or necessary.

In an alternate embodiment (not shown), circumferential flange 12 may also have a cylindrical shape, having a cylindrical projection 14 projecting into the base layer 34. The projection 14 has an axial length approximately equal to the thickness of the base layer 34 and the flange opening 15 passing through the projection 14 in the axial direction. The cylindrical projection 14 includes a lip at the end of the projection 14 inserted below the base layer 34. The lip extends radially outward from the projection 14. As an alternative, the lip may have a spiral shape extending radially outward beyond the projection 14, wherein the minimum radius of the lip is approximately equal to the radius of the projection 14, and the maximum radius of the lip is greater than the maximum dimension of the base layer opening 17.

The attachments point(s) 31 generally are mounted to and/or defined in and/or extend through a suitably rigid surface below an optional, aesthetically pleasing finish layer. The attachment point(s) 31 may be a bar 32 affixed to the body of the vehicle, an eye bolt affixed to the body of the vehicle, a bracket and bolt assembly 32′mounted to (for example) the package tray 33, and/or any other structure to which a tether 40 may be removably attached.

Base layer 34 may comprise such a finish layer and may be formed from carpeting or the like, as shown in FIGS. 1-3. Further, it is to be understood that the term “base layer” 34 as used herein encompasses not only a finish layer such as carpeting or the like, but rather also encompasses any surface through which access is provided to the attachment point(s) 31, including the interior floor 35 of a vehicle, the package tray 33, or the like. Further, the rigid surface may be the package tray 33 (as shown in FIG. 5), the floor 35 of the vehicle (as shown in FIG. 4), or the like.

Cover 10 may be shaped to fit a standard opening in a desirably located and suitably rigid surface and/or base layer 34 (as discussed hereinabove) of a vehicle.

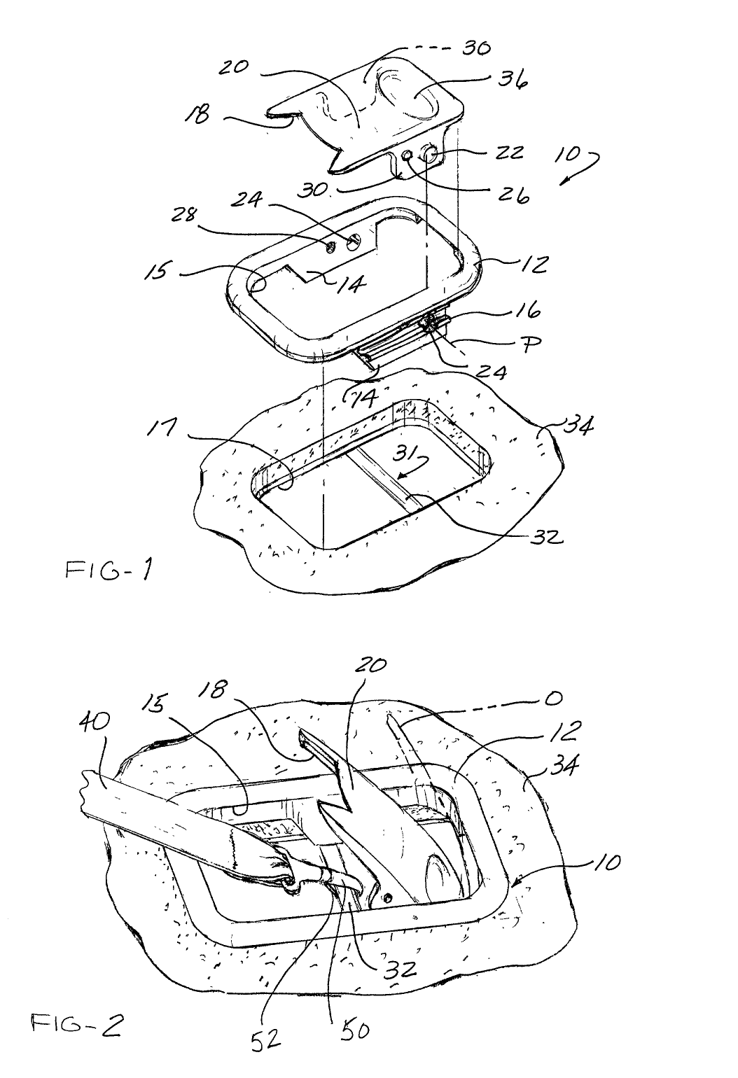

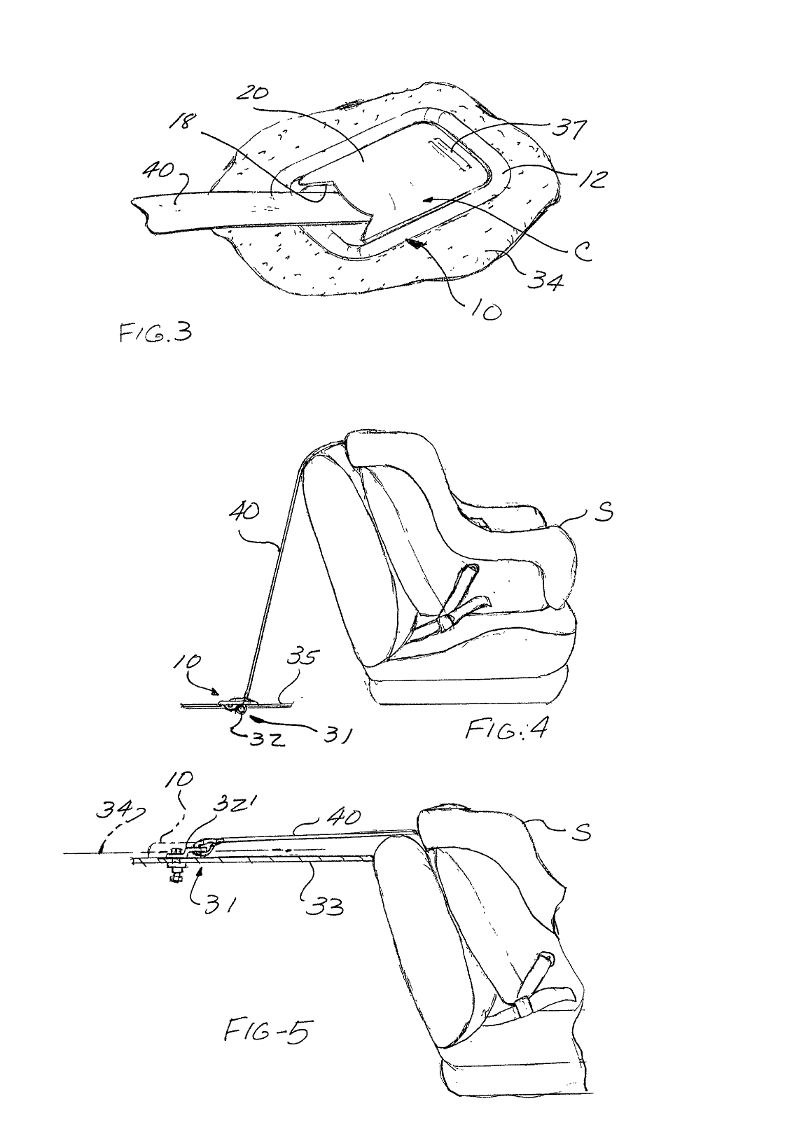

Cover 10 further comprises a cap 20 receivable within the circumferential flange opening 15. Cap 20 may be rotatably attached to the circumferential flange 12 and selectively movable about a pivot point P from a closed position C (see FIG. 3) to an open position 0 (see FIG. 2). Cap 20 may optionally include at least one wall 30 extending into the flange opening 15. Cap 20 is for substantially covering the opening 15 in the flange. Cap 20 may be shaped to be receivable within the flange opening 15. The cap 20 may also be sized and shaped so as to cover the attachment point 31, even if the attachment point 31 projects above the base layer 34.

Cap 20 may further optionally include an indentation 36 for assisting in moving the cap 20, the indentation 36 disposed on the cap upper surface and opposed to the notch 18. Alternately and/or additionally, cap 20 may include a corrugation(s) 37 for assisting in moving the cap, the corrugation 37 disposed on the cap upper surface and opposed to the notch 18, as shown in FIG. 3. The indentation 36 and/or corrugation 37 is provided as a finger location and a grip for pressing the cap 20 to rotate the cap 20 to the open position. The indentation 36/corrugation 37 is for convenience in locating the area to press for moving cap 20 to the open position. The indentation 36 may be pressed by any object that is convenient for moving the cap 20 to the open position. The indentation 36 and/or corrugation 37 is not an essential feature, and in an alternative, the cap 20 may be made without these features.

A notch 18 may be defined in either the flange 12, the cap 20, or both, and preferably at an area spaced from the pivot point P. In the Figures, notch 18 is shown defined in the cap 20. Although notch 18 may be located in any suitable area, it is preferably defined in the cap 20 at an area spaced from the pivot point P, and more preferably, at an area distal to the pivot point P. As best seen in FIG. 3, notch 18 is adapted to allow the tether 40 to pass therethrough when the cap 20 is in the closed position C. Thus, cover 10 provides a sleek, finished appearance in covering the attachment point 31, and aids in preventing foreign objects from falling into opening 15 and/or opening 17. Cover 10 provides such a finished, aesthetically pleasing appearance whether the tether 40 is in use or not.

The flange 12 may optionally include at least one projection 14 for an interference fit into the base layer opening 17. In the preferred embodiment, there are two opposed projections 14 extending from the flange 12 and adapted to extend into the base layer opening 17. Projection(s) 14 facilitate attachment of the flange 12 to the base layer 34. The projections 14 may further optionally include one or more interference ribs 16 for facilitating gripping of the base layer 34 by the flange 12. In the alternative, the projections 14 do not have interference ribs 16, but merely grip the base layer 34 by friction between the base layer 34 and the projections 14.

The flange 12 may be shaped as a bezel, or other similar shape, where the edge of the flange 12 is sloped to provide a relatively smooth contour to minimize snagging or catching of items sliding or rolling on the base layer 34.

As best seen in FIG. 1, the cap 20 also may includes at least one pin 26 for substantially preventing the cap 20 from rotating beyond the closed position C. A corresponding detent 28 is located on the flange 12. Detent(s) 28 are releasably engageable with the pins 26. In an alternative, the pin 26 may be disposed on the flange 12 and project into the circumferential flange opening 15, with the detent 28 disposed on the cap 20.

Cover 10 of the present invention further comprises means for rotatably coupling the cap 20 to the flange 12. It is to be understood that this rotatable coupling means may comprise any suitable means; however, in the preferred embodiment, this means comprises either a spindle 22 or a recess 24 disposed on the flange 12; and the other of the recess 24 or spindle 22 disposed on the cap 20. FIG. 1 depicts a pair of opposed recesses 24 defined in the flange 12, and a pair of opposed spindles 22 on the cap 20, the adjacent mating spindles/recesses being rotatably engageable. In a preferred embodiment, recesses 24 are defined in projections 14, and spindles 22 extend outwardly from cap walls 30. Alternately, there may be one spindle 22 and one recess 24 on the cap 20, with the complementary recess 24 and spindle 22 on the flange 12.

It is to be understood that recess 24 and spindle 22 may be of any suitable size and shape, however, in a preferred embodiment, the recess 24 is a circular aperture, and the spindle 22 is cylindrically shaped. It is within the purview of the invention that the spindles 22 may be any round shape including spherical sections, or frustum shaped projections. Consequently, it is within the purview of the invention that the recesses 24 may be any round shaped seat, including spherically-shaped or conically-shaped indentations.

As shown in FIG. 2, the cover 10 is fully assembled and attached to the base layer 34 with the flange 12 seated in the base layer opening 17. The cap 20 is rotatably attached to the flange 12, whereby the cap 20 may be selectively rotated to an open position. Cap 20 is shown in a position intermediate the open position O and the closed position C, and in phantom is shown in the open position O. In the open position, access is provided to the attachment bar 32, and the tether 40 is attached via a suitable attachment means such as a hook 50 with a releasable locking tongue 52 normally biased in the closed (locked) position, as best seen in FIG. 2. The tether attachment means may also comprise a bracket and bolt assembly as shown in FIG. 5.

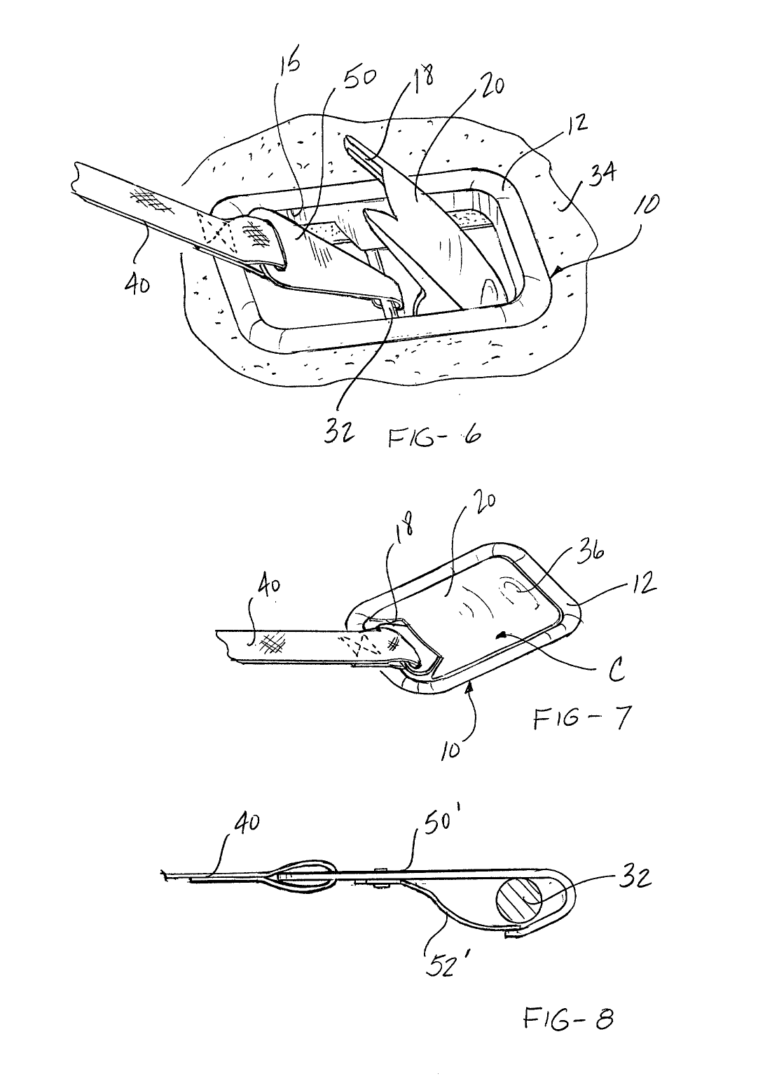

Although it is to be understood that the cover 10 of the present invention may advantageously work with any suitable tether attachment means, in the preferred embodiment, the tether attachment means is the attachment hook 50′shown in FIGS. 6-8. As best seen in FIG. 7, the notch 18 is complementarily shaped to the bracket end (which defines the aperture through which the end of the tether 40 is looped) of hook 50′. Due to this complementary shaping, the cover 10 of the present invention presents an even more sleek, aesthetically pleasing and customized look. In FIG. 8, the locking tongue 52′ is shown in its biased/closed position, thereby engaging with hook 50′ about bar 32. Tongue 52′ substantially prevents inadvertent release of hook 50′ from bar 32. Hook 50′ may easily be released from bar 32 when desired by pulling hook 50′ against bar 32 and then depressing tongue 52′ until an opening is formed sufficient to pass bar 32 therethrough. The lock/release mechanism of hook 50/tongue 52 functions in the same manner as described immediately hereinabove.

The notch 18 in the cap 20 provides for passage of the tether 40 through the flange opening 15 and closure of the cap 20, as shown in FIG. 3. As an alternative, the notch 18 may be disposed in the flange 12, and the cap 20 may be designed without the notch 18.

FIG. 4 provides a view of the anchor system cover 10 shown installed in a vehicle floor 35. Cover 10 is in the closed position with a tether 40 extending from the attachment bar 32 to the child seat S.

It is also contemplated that base layer 34 may cover the attachment point 31, and when a vehicle owner desires access, the owner would then cut an opening 17 in the base layer 34. Such a situation might entail a stiff carpeting over an opening to the attachment point 31.

While preferred embodiments, forms and arrangements of parts of the invention have been described in detail, it will be apparent to those skilled in the art that the disclosed embodiments may be modified. Therefore, the foregoing description is to be considered exemplary rather than limiting, and the true scope of the invention is that defined in the following claims.

What is claimed is:

1. A cover for an anchor system having an attachment point adjacent a base layer opening and a tether selectively detachably connected to the attachment point, the cover comprising:
a circumferential flange defining an opening therein, and adapted to be operatively connected to the base layer opening;
a cap receivable within the circumferential flange opening, the cap being rotatably attached to the circumferential flange and selectively movable about a pivot point from a closed position to an open position; and
a notch defined in at least one of the flange and the cap, the notch adapted to allow the tether to pass therethrough when the cap is in the closed position.

2. The cover as defined in claim 1 wherein the notch is defined in the cap at an area spaced from the pivot point.

3. The cover as defined in claim 1 wherein the circumferential flange has at least one projection extending from the flange and adapted to extend into the base layer opening.

4. The cover as defined in claim 3 wherein the at least one projection has at least one interference rib.

5. The cover as defined in claim 2 wherein the cap has an upper surface and an indentation for assisting in moving the cap, the indentation disposed on the upper surface and opposed to the notch.

6. The cover as defined in claim 1 wherein the notch is defined in the circumferential flange at an area spaced from the pivot point.

7. The cover as defined in claim 1 wherein the circumferential flange is a bezel.

8. The cover as defined in claim 1 wherein the attachment point is a bolt projecting above the base layer, and the cap is adapted to cover the bolt.

9. The cover as defined in claim 1 wherein the circumferential flange further comprises at least one pin projecting into the circumferential flange opening.

10. The cover as defined in claim 9 wherein the cap further comprises at least one detent releasably engageable with the at least one pin.

11. The cover as defined in claim 1 wherein the cap further comprises at least one pin projecting outwardly therefrom.

12. The cover as defined in claim 11 wherein the flange further comprises at least one detent releasably engageable with the at least one pin.

13. The cover as defined in claim 2 wherein the cap has an upper surface and a corrugation for assisting in moving the cap, the corrugation disposed on the upper surface and opposed to the notch.

14. The cover as defined in claim 1, further comprising means for rotatably coupling the cap to the flange.

15. The cover as defined in claim 14 wherein the rotatable coupling means comprises:
one of a spindle and a recess disposed on the flange; and
the other of a recess and a spindle disposed on the cap.

16. The cover as defined in claim 15 wherein the spindle extends from the cap and the recess is defined in the flange.

17. The cover as defined in claim 16 wherein the cap further comprises at least one wall extending into the flange opening, and wherein the spindle is located on the at least one wall.

18. A cover for a child safety seat anchor system having an attachment point adjacent a base layer having an opening therethrough and a tether selectively detachably connected to the attachment point, the cover comprising:
a circumferential flange defining an opening therein, and adapted to be operatively connected to the base layer opening;
at least one projection extending from the flange and adapted to extend into the base layer opening, wherein the at least one projection has at least one interference rib;
a cap receivable within the circumferential flange opening, the cap being rotatably attached to the circumferential flange and selectively movable about a pivot point from a closed position to an open position; and
a notch defined in the cap at an area spaced from the pivot point, the notch adapted to allow the tether to pass therethrough when the cap is in the closed position.

19. The cover as defined in claim 18 wherein the circumferential flange opening is adapted to be shaped complementarily with the base layer opening.

20. The cover as defined in claim 19, further comprising means for rotatably coupling the cap to the flange, wherein the rotatable coupling means comprises:
one of a spindle and a recess disposed on the at least one projection; and
the other of a recess and a spindle disposed on the cap.

21. The cover as defined in claim 20 wherein the spindle extends from the cap and the recess is defined in the at least one projection.

22. The cover as defined in claim 21 wherein the recess is a circular aperture, and the spindle is cylindrically shaped.

23. A cover for a motor vehicle child safety seat anchor system having an attachment point adjacent a base layer having an opening therethrough and a tether selectively detachably connected to the attachment point, the cover comprising:
a circumferential flange defining an opening therein, and adapted to be operatively connected to the base layer opening;
two opposed projections extending from the flange and adapted to extend into the base layer opening, wherein each of the projections has at least one interference rib;
a cap receivable within the circumferential flange opening and having two opposed walls extending into the flange opening, the cap being rotatably attached to the circumferential flange and selectively movable about a pivot point from a closed position to an open position;
means for rotatably coupling the cap to the flange, wherein the rotatable coupling means comprises:
a spindle extending outwardly from each of the two opposed walls; and
a recess defined in each of the two opposed projections;
a notch defined in the cap at an area distal to the pivot point, the notch adapted to allow the tether to pass therethrough when the cap is in the closed position;
a pin projecting outwardly from each of the two opposed walls; and
a detent defined in each of the two opposed projections, the detents being releasably engageable with the pins.

24. The cover as defined in claim 23 wherein the cap has an upper surface and an indentation for assisting in moving the cap, the indentation disposed on the upper surface and opposed to the notch.
